(19) United States
(12) Patent Application Publication
(10) Pub. No.: US 2005/0238547 A1
(43) Pub. Date: Oct. 27, 2005

(54) Multi-media, multi-sensory advertising kiosk

(76) Inventor: Arnold J. Foppe JR., St. Louis, MO (US)

Correspondence Address: Arnold J. Foppe, Jr., 5112 Crossword Dr., St. Louis, MO, 63129-2409, US

(21) Appl. No.: 10/830,515

(22) Filed: Apr. 23, 2004

(51) Int. Cl. A62B 7/08

(52) U.S. Cl. 422/124; 239/289; 239/433; 261/78.1

(57) ABSTRACT

The invention is a multi-media, multi-sensory advertisement kiosk for displaying advertisements to the public. The kiosk comprises a base, a frame which is supported by the base which includes an advertisement display area, and a misting apparatus. The kiosk may be designed with one or more of the following: an audio system, a scent dispensing apparatus, and a light apparatus. The advertisement display area may contain practically any media for advertising, including but not limited to a sheet of advertising copy, a poster, high resolution graphics, 3 D graphics, multi image technology, other animated graphics, a plasma screen television, and a touch screen panel. The frame may be designed in practically any shape, including but not limited to a bottle, a can, or a cartoon character.

### BACKGROUND OF THE INVENTION

1. Field of the Invention

This invention relates generally to a display apparatus and, more particularly, to a portable multi-media, multi-sensory advertising kiosk.

2. Related Art

A kiosk is an advertising display apparatus such as a frame, pedestal or hollow electrical enclosure arranged to be mounted on some surface. Kiosks are designed to stand alone and therefore, can be used in places even where wall space is not available. For instance, kiosks can be used in supermarkets, theme parks, golf courses, sports arenas, sidewalks, etc. Kiosks also have the advantage of being easily moved to new locations. Photographs, 3 D graphics, high resolution graphics, animated graphics, touch screen panels, plasma televisions or similar features may be mounted on a kiosk. Kiosks are accessible from all sides and therefore allow a passerby to easily view an advertisement.

U.S. Pat. No. 6,427,369 (the “'369 patent”) issued to Durinzi, Jr. in 2002 discloses an advertising kiosk suitable for outdoors to display advertising copy while protecting it from the elements. The advertising kiosk further illuminates the sheets of advertisements by lamps in the interior of the kiosk. The kiosk disclosed in the '369 patent has a stainless steel outer surface to render it weather resistant.

U.S. Pat. No. 4,608,773 (the “'773 patent”) issued to White in 1986 discloses a kiosk display unit utilizing a sheet metal base pedestal which comprises a plurality of identical panels. The main objective of the '773 patent is to provide an inexpensive and easily assembled kiosk that is both strong, stable and structurally simple.

Various ornamental designs for advertising kiosks exist in the following U.S. Design Pat. No.: D463,032, D377,197, D362,024, and D357,944.

While this prior art does disclose the use of kiosks for advertising, none of this prior art discloses the use of kiosks for multi-media, multi-sensory advertising. The '369 patent discloses the use of illuminated advertisements but does not reveal any additional media or sensory features.

### SUMMARY OF THE INVENTION

An aspect of the present invention is to provide an advertising kiosk that provides multi-media and multi-sensory features which may include one or more of the following features: a misting apparatus, an audio system, a scent dispensing apparatus, and a lighting apparatus.

Another aspect of the present invention is to provide a multi-media, multi-sensory kiosk which is self-contained.

Yet another aspect of the present invention is to provide a multi-media, multi-sensory kiosk which is portable.

Another aspect of the present invention is to provide a motor which drives both an air blower and a water pump.

In accordance with one or more of the above aspects of the invention, there is provided a multi-media, multi-sensory kiosk that comprises a base, a frame which is supported by the base and includes a visual display area, and a misting apparatus. In one embodiment the misting apparatus comprises a motor which drives both an air blower apparatus and a water pump apparatus. In an alternative embodiment, the multi-sensory kiosk comprises additional features including one or more of the following: an audio system, a scent dispensing apparatus, and a light apparatus. In another embodiment, the visual display area includes a plasma screen television. In another alternative embodiment, the frame may be in the shape of a bottle, a can, or a cartoon character.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the view.

FIG. 1 illustrates a front view of a kiosk according to an embodiment of the present invention.

FIG. 2 illustrates a side view of the kiosk of FIG. 1;

FIG. 3 illustrates a back view of the kiosk of FIG. 1;

FIG. 4 illustrates a front view of the tubing detail of the kiosk according to an embodiment of the present invention;

FIG. 5 illustrates a side view of the tubing detail of a kiosk of FIG. 4; and

FIG. 6 illustrates a back view of the tubing detail of the kiosk of FIG. 4.

### DETAILED DESCRIPTION OF THE PREFERRED EMBODIMENTS

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted. In other instances, well-known methods, procedures, and components have not been described in detail so as not to obscure the present invention.

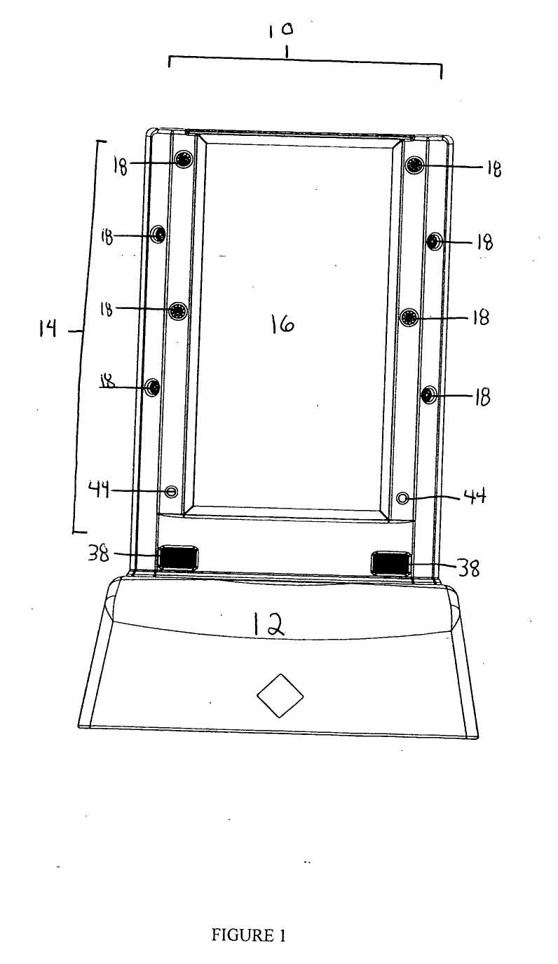

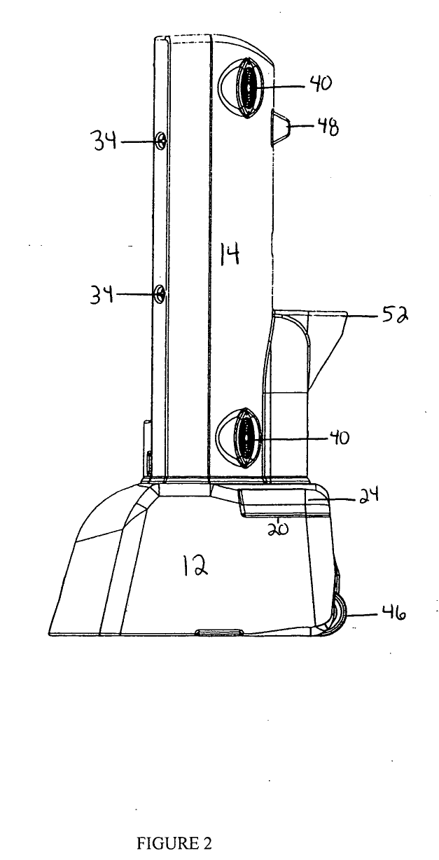

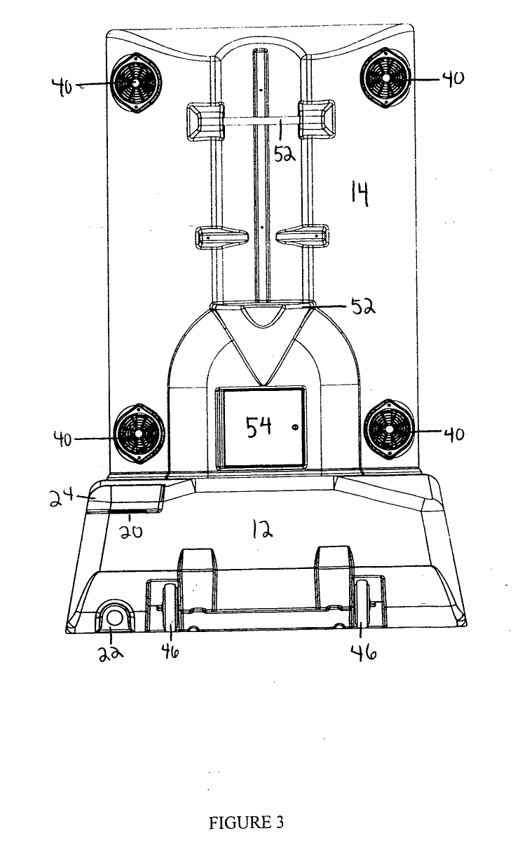

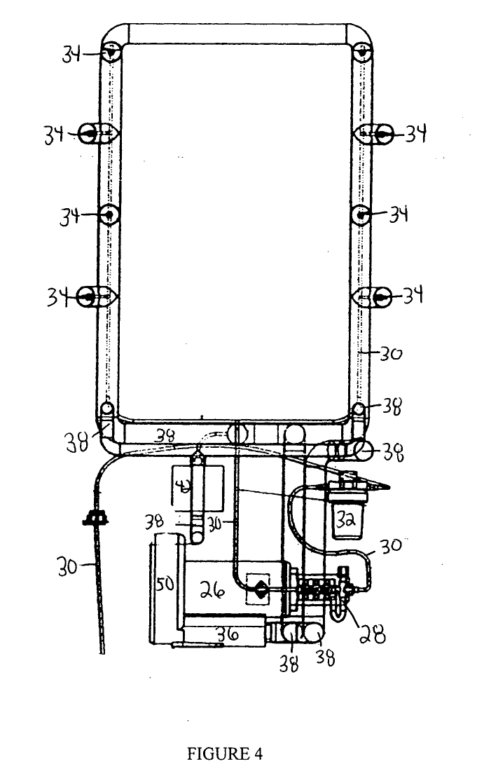

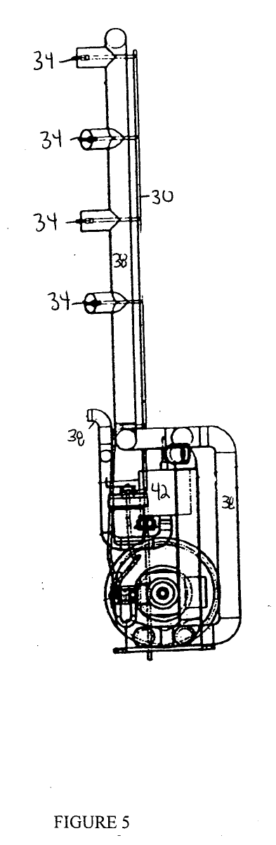

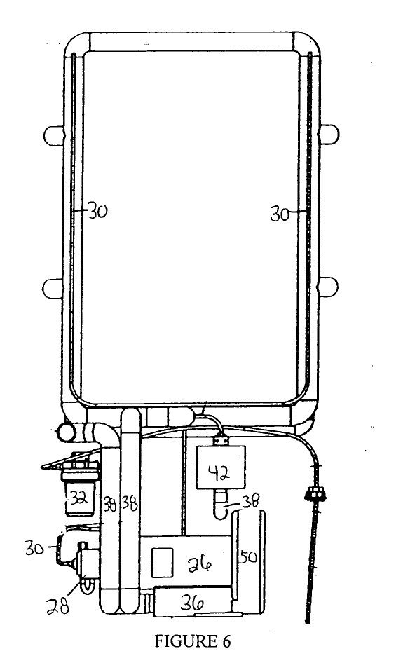

FIGS. 1-6 illustrate a portable multi-media, multi-sensory advertising kiosk 10. The kiosk 10 is primarily composed of a base 12, a frame 14 supported by the base 12 having a visual display area 16, and a misting apparatus 18. The base 12 may be constructed of practically any rigid material, including wood, plastic, metal, or composites. The base 12 may be constructed in practically any shape and with practically any design. However, in the preferred embodiment, the base 12 is constructed of linear low density polyethylene plastic with a rock design. The base 12 may be constructed with a water tank. The water tank may contain a fill hole 20 and drain hole 22 for filling and draining the tank. In the preferred embodiment, the fill hole 20 is covered with a lockable cap 24 to prevent a person from tampering with the water supply.

The frame 14 may be constructed of practically any rigid material, including wood, plastic, metal, or composites. The frame 14 may also be constructed into practically any shape, including but not limited to a rectangle, a bottle, a can, and a cartoon character. In the preferred embodiment, the frame 14 is constructed of linear low density polyethylene plastic and is in a rectangular shape. The frame 14 has a visual display area 16. The visual display area 16 may contain practically any media for advertising or other desired visual images, including but not limited to a sheet of advertising copy, a poster, high resolution graphics, 3 D graphics, multi image technology, other animated graphics, a plasma screen television, and a touch screen panel.

The misting apparatus 18 provides a mist of water to the area near, within, or surrounding the kiosk. The mist of water may flash evaporate to prevent a person from getting wet. In the preferred embodiment, the misting apparatus 18 comprises a motor 26, a water pump apparatus 28, at least one water line 30, a water filter system 32, at least one misting nozzle 34, an air blower apparatus 36, and at least one air tube 38. The motor 26 drives both the water pump apparatus 28 and the air blower apparatus 36. The water pump apparatus 28 pumps water via the water line 30 to the misting nozzles 34. The misting nozzles 34 may be located adjacent the advertisement area. The water filter system 32 is connected to the water line 30 and filters the water as it passes though the system. The air blower apparatus 36 blows air via the air tube 38 to the misting nozzles 34. The misting nozzles 34 provide a cool refreshing mist to the area surrounding the kiosk.

The water supply may come from water within the water tank, water from a faucet, water from a hose, or any other means for providing water. The air may be supplied from the air outside the kiosk 10 and drawn into the blower via an air tube 38. In another embodiment, at least one of the misting nozzles 34 is angled at forty degrees away from the visual display area 16 to prevent people from standing directly in front of the display

In the preferred embodiment, the kiosk 10 also comprises one or more of the following: an audio system 40, a scent dispensing apparatus 42, and a lighting apparatus 44. The audio system 40 may be practically any audio system, including but not limited to a media player, a radio, a stereo, a cd player, a tape player, or an audio message repeater. The scent dispensing apparatus 42 provides scent to the air surrounding the kiosk. In the preferred embodiment, the scent dispensing apparatus 42 comprises a motor 26, an air blower apparatus 36, a scent canister 42, and at least one air tube 38. The same motor 26 which drives the water pump apparatus 28 may drive the air blower 36 which blows air through the air tubes 38. The air tubes 38 connect to the scent canister which scents the air as it passes through the scent canister 42. This scented air is then dispersed into the area surrounding the kiosk 10 via the air tubes 38. The lighting apparatus 44 illuminates the advertisement display area 16 or the area surrounding the kiosk. The lighting apparatus 44 may be practically any apparatus which illuminates an area including, but not limited to, incandescent, fluorescent, or spot lights. The lighting apparatus 44 may be stationary or motorized to render the illumination active.

The multi-media, multi-sensory advertising kiosk 10 is readily portable. In the preferred embodiment, the kiosk includes an axis connected with the base, a pair of wheels 46 rotatably mounted on the axis, and a handle 48 to provide this mobility. The kiosk may be powered by practically any energy source, including but not limited to an outlet or a portable generator 50. The portable generator 50 aids in the mobility of the kiosk. Additionally, the kiosk may be self-contained because the portable generator 50, water tank, water pump apparatus 28, lighting apparatus 44, audio system 40, and scent dispensing apparatus 42 are contained within the kiosk 10 eliminating the need for any water or power line running between the kiosk and an outside source.

In another embodiment, the kiosk includes a stand 52 located on the back of the kiosk for supporting a water cooler, a promotions dispenser, or any other device or structure. The stand may be constructed of practically any rigid material, including wood, plastic, metal, or composites.

In another embodiment, the kiosk 10 includes an electrical panel 54. The electrical panel 54 may include a thermostat, a thermostat timer, a toggle switch, and other electrical components that aid in the operation of the kiosk 10. The thermostat detects the ambient temperature of the air surrounding the kiosk 54. The kiosk 10 may be designed to become active once the ambient temperature reaches a desired set point and inactive if the ambient temperature falls below the set point. The thermostat timer may be used to program the thermostat for a desired time of operation. The toggle switch may provide a manual override of the kiosk functions. The toggle switch may also be designed to allow the kiosk 10 to be set for either “mist” or “air only” operation.

In another embodiment, the kiosk may also be designed for use on a golf course. The golf kiosk may include one or more of the following elements: waste basket and waste basket mount, a water jug, a ball washer pipe, a ball washer L bracket, a golf shoe cleaner, and a club cleaner. The graphics on the visual display area 16 may include a digital layout of the hole design or other golf graphics.

In yet another embodiment, the kiosk may be designed as a grocery unit in which the product is placed on the base of the kiosk.

Other objects, features and advantages of the present invention will be apparent to those skilled in the art. While preferred embodiments of the present invention have been illustrated and described, this has been by way of illustration and the invention should not be limited.

1. A multi-media, multi-sensory kiosk, comprising
a base;
a frame supported by said base, said frame having a visual display area;
an audio system; and
a misting apparatus.

2. The multi-media, multi-sensory kiosk of claim 1, further comprising a scent dispensing apparatus.

3. The multi-media, multi-sensory kiosk of claim 2 wherein said scent dispensing apparatus comprises a motor; and an air blower fluidly connected with a scent canister; wherein said motor drives said air blower.

4. The multi-media, multi-sensory kiosk of claim 2 wherein said scent apparatus is contained within said kiosk.

5. The multi-media, multi-sensory kiosk of claim 1 wherein said audio system comprises a media player and at least one speaker connected with said media player.

6. The multi-media, multi-sensory kiosk of claim 1 wherein said kiosk is portable.

7. The multi-media, multi-sensory kiosk of claim 6 further comprising: a handle connected with said kiosk; an axis connected with said base; and a pair of wheels rotatably mounted on said axis.

8. The multi-media, multi-sensory kiosk of claim 1 wherein said visual display area includes a plasma screen television.

9. The multi-media, multi-sensory kiosk of claim 1 wherein said visual display area includes a touch screen panel.

10. The multi-media, multi-sensory kiosk of claim 1 further comprising a lighting apparatus.

11. The multi-media, multi sensory kiosk of claim 10 wherein said lighting apparatus includes a stationary light source.

12. The multi-media, multi-sensory kiosk of claim 10 wherein said lighting apparatus includes a motorized, moving light source.

13. The multi-media, multi-sensory kiosk of claim 1 wherein said frame is a customized shape.

14. The frame of claim 13 wherein said customized shape is selected from the group consisting of: a bottle, a can, and a cartoon character.

15. The multi-media, multi-sensory kiosk of claim 1 wherein said misting apparatus comprises a motor; an air blower; a water pump; and at least one misting nozzle; wherein said motor drives said air blower apparatus and said water pump apparatus and wherein said water pump is fluidly connected to said misting nozzle and wherein said air blower is fluidly connected to said misting nozzle.

16. The multi-media, multi-sensory kiosk of claim 1 further comprising a water tank and a power generator and wherein said water tank, said power generator, said audio system, and said misting apparatus are contained within said kiosk rendering said kiosk a self contained unit.

17. A multi-media, multi-sensory kiosk, comprising
a base;
a frame supported by said base, said frame having a visual display area;
an audio system;
a misting apparatus; and
a scent dispensing apparatus.

18. The multi-media, multi-sensory kiosk of claim 17 wherein said scent dispensing apparatus comprises a motor; and an air blower fluidly connected with a scent canister; wherein said motor drives said air blower.

19. The multi-media, multi-sensory kiosk of claim 17 wherein said audio system comprises a media player and at least one speaker connected with said media player.

20. The multi-media, multi-sensory kiosk of claim 17 wherein said kiosk is portable.

21. The multi-media, multi-sensory kiosk of claim 20 further comprising: a handle connected with said kiosk; an axis connected with said base; and a pair of wheels rotatably mounted on said axis.

22. The multi-media, multi-sensory kiosk of claim 17 wherein said visual display area includes a plasma screen television.

23. The multi-media, multi-sensory kiosk of claim 17 wherein said visual display area includes a touch screen panel.

24. The multi-media, multi-sensory kiosk of claim 17 further comprising a lighting apparatus.

25. The multi-media, multi sensory kiosk of claim 24 wherein said lighting apparatus includes a stationary light.

26. The multi-media, multi sensory kiosk of claim 24 wherein said lighting apparatus includes a motorized, moving light source.

27. The multi-media, multi-sensory kiosk of claim 17 wherein said frame is a customized shape.

28. The frame of claim 27 wherein said customized shape is selected from the group consisting of: a bottle, a can, or a cartoon character.

29. The multi-media, multi-sensory kiosk of claim 17 wherein said misting apparatus comprises a motor; an air blower; a water pump; and at least one misting nozzle; wherein said motor drives said air blower apparatus and said water pump apparatus and wherein said water pump is fluidly connected to said misting nozzle and wherein said air blower is fluidly connected to said misting nozzle.

30. The multi-media, multi-sensory kiosk of claim 17 further comprising a water tank and a power generator and wherein said water tank, said power generator, said audio system, said misting apparatus, and said scent dispensing apparatus are contained within said kiosk rendering said kiosk a self contained unit.

31. A multi-media, multi-sensory kiosk, comprising
a base;
a frame supported by said base, said frame having a visual display area;
an audio system; wherein said audio system comprises a media player and at least one speaker connected with said media player;
a misting apparatus; wherein said misting apparatus comprises a motor;
an air blower;
a water pump; and at least one misting nozzle; wherein said motor drives said air blower apparatus and said water pump apparatus and wherein said water pump is fluidly connected to said misting nozzle and wherein said air blower is fluidly connected to said misting nozzle; and
a scent dispensing apparatus, wherein said scent dispensing apparatus comprises a motor; and an air blower fluidly connected with a scent canister; wherein said motor drives said air blower.
